(19) United States
(12) Patent Application Publication
(10) Pub. No.: US 2022/0275938 A1
(43) Pub. Date: Sep. 1, 2022

(54) FLAME DISPLAY SYSTEM AND METHODS

(71) Applicant: TKIP Holdings, LLC, Vancouver, WA (US)

(72) Inventor: Trent Farrer, Vancouver, WA (US)

(21) Appl. No.: 17/648,801

(22) Filed: Jan. 24, 2022

Related U.S. Application Data
(63) Continuation-in-part of application No. 16/005,325, filed on Jun. 11, 2018, now Pat. No. 11,231,173.
Application No. 16/005,325 is a continuation of application No. 15/971,551, filed on May 4, 2018, now abandoned.
(60) Provisional application No. 62/501,604, filed on May 4, 2017.

(51) Int. Cl. F23N 5/20; G06F 3/16; F23N 1/00

(52) U.S. Cl. CPC F23N 5/203; G06F 3/16; F23N 1/002; F23D 14/28

(57) ABSTRACT

Methods and systems for a flame display may comprise flowing fuel from a fuel source to a burner via an electric valve fuel passage that includes an electric valve and via a mechanical valve fuel passage that includes a mechanical valve, receiving a flame boost mode request, and adjusting the electric valve to a wide open position. The flame display may further be operated in a music mode in which the electric valve is adjusted based on an audio input or in a standard mode.

COPYRIGHT NOTICE© 2017-2022 TK Products, LLC. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.7I(d).

### BACKGROUND AND SUMMARY

Fire is often used for decorative or entertainment effects, for example, in fire pits or theatrical displays. Sometimes, bursts of flame may be triggered in conjunction with music or other inputs. Fire is further often used as an ambient heat source or directed heat source. For example, fire may be used as a directed heat source to heat attachments such as griddles and grills which may be placed on top of a flame display. Examples are disclosed, for example, in U.S. Pat. Nos. 5,890,485; 6,413,079; and 8,823,714 (Thielvoldt). Thielvoldt's “Music-Reactive Fire Display” utilizes a digital signal processor programmed to analyze a music input signal and generate a “visualization signal” output to control a flame display responsive to the music. That type of system requires relatively expensive and complicated digital components and software. The need remains for simpler, less expensive, yet effective methods and circuits to control a fire display responsive to music, so that the music and fire display together form an attractive and compelling audio-visual experience. Moreover, the inventor has further recognized a need for such a fire display to have various operating mode options to enable the fire display to be adapted to the various uses for fire, such as ambient or directed heating. The disclosure that follows solves this and other problems.

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

In one aspect, a system according to invention may comprise:

a base unit including an analog base unit controller circuit arranged to receive an audio input signal and generate an analog control signal that is responsive to the audio input signal;

a control wire connectable to the base unit to distribute the analog control signal; and

a flame display unit electrically connectable to the control wire to receive the analog control signal;

the flame display unit including a combustible fuel source to generate an open flame;

and the flame display unit including a proportional valve to control flow of fuel from the fuel source so as to controllably vary a height of the open flame responsive to the analog control circuit during operation of the flame display unit. Varying the height of the open flame responsive to the audio input signal may be referred to as a music operational mode herein. It is noted that flame display may be operated in the music operational mode responsive to receiving a user input. This user input may be received via one or more of a button, dial, or other user input device of the flame display, for example.

In some embodiments, the flame display unit includes a flame control circuit arranged to receive the analog control signal and generate an analog valve position signal; and the flame control circuit is arranged to utilize the analog valve position signal to control electrical current in the proportional valve during operation, thereby producing an active flame show responsive to the audio input signal.

In at least one embodiment, the flame control circuit may be arranged to present a high impedance to the control wire while receiving the analog control signal so as to minimize loading the analog control signal. Multiple flame display units may each contain a corresponding flame control circuit, and all of the control circuits may be coupled to the common control wire to control their operation. In some embodiments, the control units may be electrically (mechanically) connected to a common control wire to receive the analog control signal. In other embodiments, the control signal may be distributed from a base unit using wireless (radio) technology. Many flame display units may be controlled by a single base unit.

In another aspect, a system may provide multiple flames during operation, each of them varying synchronously responsive to the analog control signal. The specific flame size, color, height, and magnitude of variations may vary across different flame display units within a system. For example, in one system, a given flame display unit may vary the flame dramatically in response to the analog input signal, while a smaller flame display unit may make more subtle changes, still synchronized to the common input signal.

In another aspect, a method comprises taking an audio input signal, full wave rectifying it, low-pass filter the signal to limit changes to the response characteristics of the gas valve. The slope of the filtered signal may be determined as positive (+/up) or negative (−/down). If up the valve is opened, if down the valve is closed. This up/down voltage may be combined with a DC offset voltage in a current summer circuit. This offset may be used to set the minimum valve drive current. In some embodiments, this voltage both sets a pilot light function and puts the valve is the maximum drive range.

Further, in one or more example methods and systems according to the present disclosure, the flame display may include a flame boost operational mode. The flame boost operational mode may be initiated responsive to a user input to a flame boost input device. This flame boost input device may be one or more of a button, dial, or other user input device of the flame display, for example. In at least one example, an electronic valve of the flame display may be commanded to a wide open position responsive to receiving the user input to the flame boost input device requesting the flame boost operational mode. A mechanical valve may further be adjusted to a wide open position as part of initiating the flame boost operational mode.

The electronic valve and the mechanical valve of the flame display are both positioned in between a fuel source and an orifice of the flame display. Thus, adjusting both the electronic valve and the mechanical valve to the wide open position for the flame boost mode enables a maximum amount of flow from the fuel source to the orifice of the flame display. In turn, strong flame production may be achieved. This strong flame production may be useful in cases where a high amount of heat is desirable, such as heating a griddle or grill for cooking via the flame display. For example, a griddle or grill may be fixed on top of the flame display and then the flame display may be adjusted to a flame boost mode to heat the griddle or grill in an efficient manner.

Additionally, methods and systems disclosed herein may include a standard operational mode for the flame display. In the standard operational mode, a user input may be received to turn the flame up or down. For example, the user input may be received via one or more of a button, dial or other user input device of the flame display. In contrast to the flame boost mode, however, the standard operational mode for the flame display does not place the electronic valve in the wide open position. Furthermore, the electric valve is not commanded responsive to an audio input (e.g., music) in either the standard operational mode or the flame boost mode. Instead, the standard operational mode includes the adjustment of the mechanical valve to a set position. Additional aspects and advantages of this invention will be apparent from the following detailed description of preferred embodiments, which proceeds with reference to the accompanying schematic diagram.

### BRIEF DESCRIPTION OF THE DRAWINGS

FIG. 1 is a simplified diagram of an example of an audio signal driven flame display system.

FIG. 2 is a simplified diagram of an example of a flame display unit compatible with a flame display system of the type illustrated in FIG. 1.

FIG. 3 is an enlarged diagram showing more detail of a flame display unit of the type illustrated in FIG. 2.

FIG. 4 is a cross-sectional diagram illustrating an example of a connector for electrical connection of a flame display unit to a flame display system control wire.

FIGS. 5A-5C together form a schematic diagram of an example base unit controller circuit for use in a flame display system of the type illustrated in FIG. 1.

FIG. 6 is a simplified diagram of an alternative embodiment of an audio signal driven flame display system utilizing wireless broadcast of a control signal.

FIG. 7 is a block diagram of an example flame display unit, according to at least one example of the present disclosure.

FIG. 8 is a flow chart of a method for operating a flame display unit, according to at least one example of the present disclosure.

FIG. 9 is a timing diagram for operating a flame display unit, according to at least one example of the present disclosure.

### DETAILED DESCRIPTION

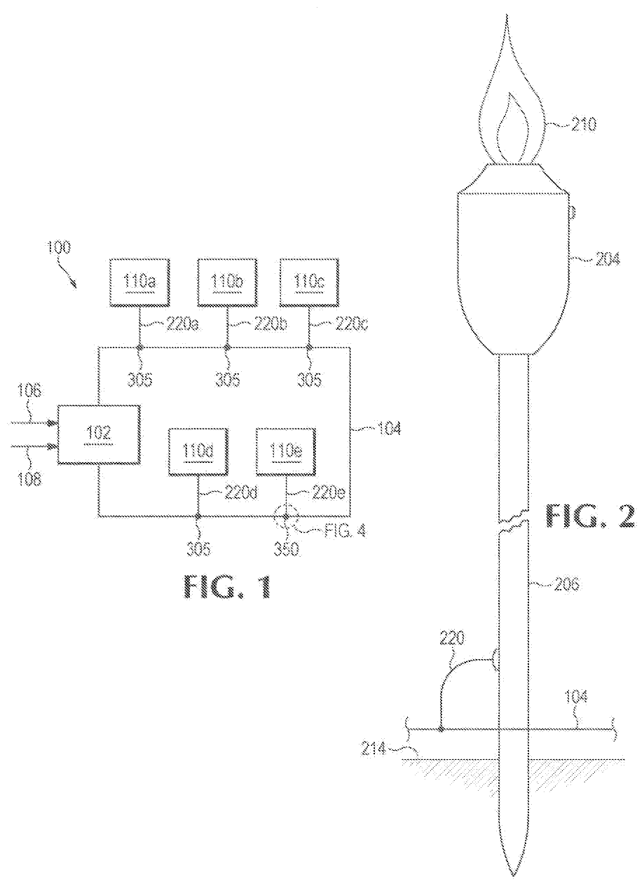

FIG. 1 is a simplified block diagram of an example of a system 100 to realize an audio input signal-driven flame display show. In this example, a base unit 102 may be used to control one or more separate flame display units, such as units 110a, 110b and 110e. The flame display units may be substantially identical, but they need not be so. Individual flame display units 110 may have different sizes, materials, flame characteristics, fuels, as well as mechanical designs, support or mounting systems, and/or decorative surface ornamentation. In some cases, one or more of the flame display units may be designed and decorated to resemble a “tiki torch,” reminiscent of the bamboo torches historically used in tiki cultures. Each of the flame display units is connectable to a common flame display system control wire 104.

The base unit 102 may have an external power source (not shown) to provide power input at 106. The power requirements will depend on the specific design of the base unit 102. The base unit 102 may be tethered to a power source, or it may contain rechargeable batteries, for example, Nickel Cadmium (NiCad) battery, Nickel-Metal Hydride (NiMH) battery, Lead Acid battery, Lithium Ion battery, Lithium Polymer battery, etc. The power source preferably is a lowvoltage DC source, for example, 12 volts.

Base unit 102 may incorporate an audio programming (content) source, such as a CD player, Internet-connected browser for streaming, microphone, etc. In other embodiments, it may provide connections 108 to receive audio signals from external audio sources such as audio entertainment systems, smart phone, etc. The source of audio signals is not limited.

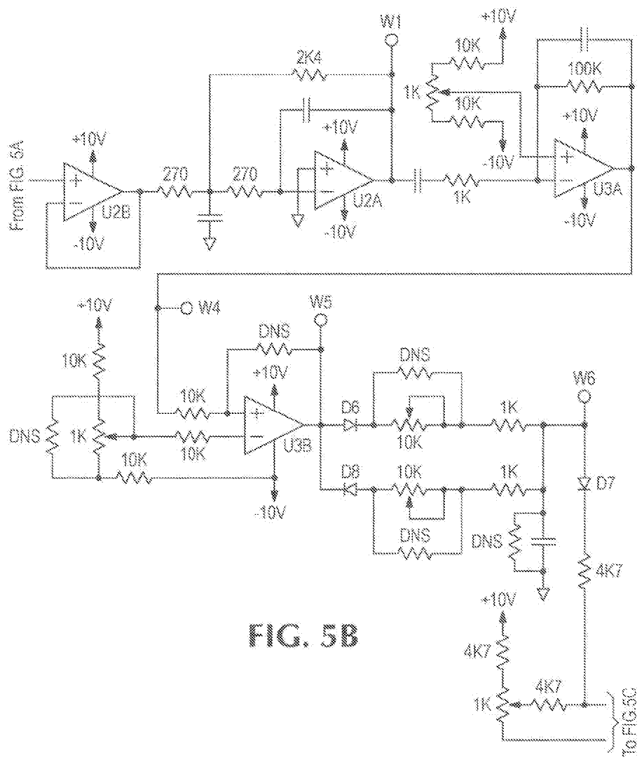

The base unit 102 contains a base unit controller circuit, described in more detail below. Briefly, the controller circuit in the base unit receives an audio input signal (from any source) and generates a control signal responsive to the audio input signal. The control signal is specially adapted for use in controlling flame displays in flame display units. The base unit applies the control signal to a control wire or cable 104, which in turn carries the control signal to all flame display units 110 that are coupled to the wire 104 to receive it. For outdoor use, for example, in a garden, the wire 104 should have a substantially weather-impermeable protective covering or coating (402 in FIG. 4). The wire 104 should have at least two electrical conductors (and may also have a separate ground or shield connection). In operation, the base unit provides the common control signal so that one or more flame display units connected to it via wire 104 can generate individual flame displays responsive to the same audio input signal in a synchronized manner. Each flame display unit may have a hookup wire 220a, 220b, etc. coupled to a connector 305 or 350 to connect the individual flame display unit to the common control wire 104. Such connections are described in more detail below with regard to FIG. 4.

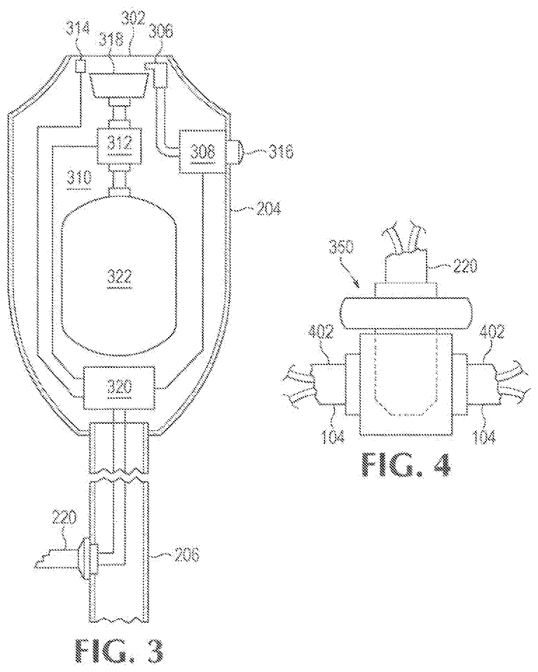

FIG. 2 is a conceptual diagram of an example flame display unit. The display unit illustrated may be used in the context the system of FIG. 1 as one of the flame display units 110a-110e. A flame display unit in one embodiment may comprise a rigid mounting pole 206 for temporarily planting the display unit into sod or grass 214 or the like. Alternatives may include a rigid base (not shown), arranged to support the display unit, for example, on a hard surface such as brick, pavers, or concrete flatwork. Various temporary or permanent mounting and support systems may be used. The design is not critical, it merely needs to provide sturdy support, so the flame display unit remains upright. For example, the flame display unit may be a fire pit, in at least one example.

The flame display unit comprises a torch section 204 securely mountable to the supporting pole 206 to hold the torch section upright. An aperture may be provided in the pole or other support structure to accommodate a hookup wire 220 extending from the torch section 204 for connection to the common control wire 104 discussed above. Routing the hookup wire 220 internally of the support pole 206 is optional but preferred. In operation, the flame display unit 200 generates a flame 210 extending from the torch unit 204, wherein the flame size or height varies responsive to a control signal imposed on the wire 104 by the base unit 102 (FIG. 1).

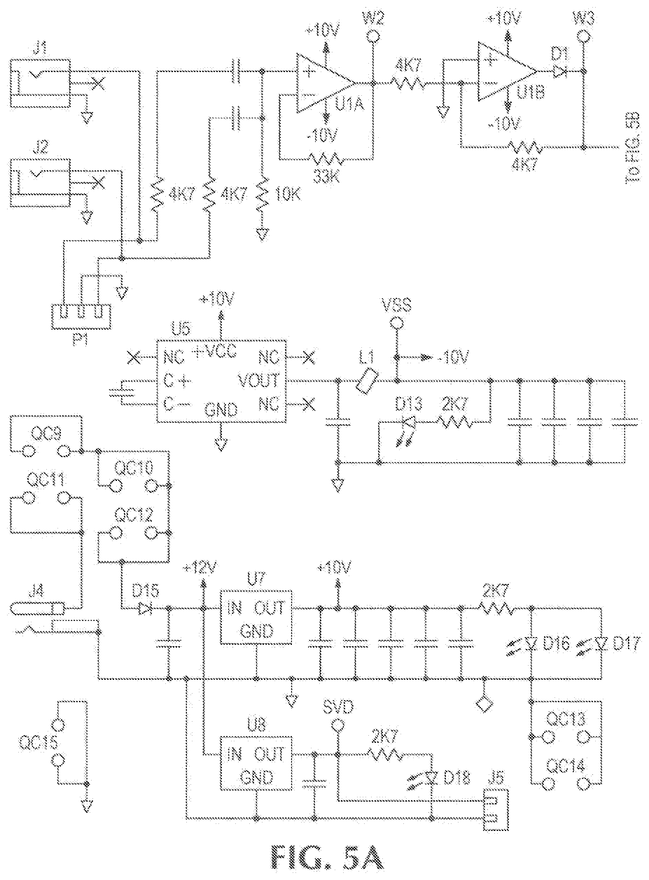

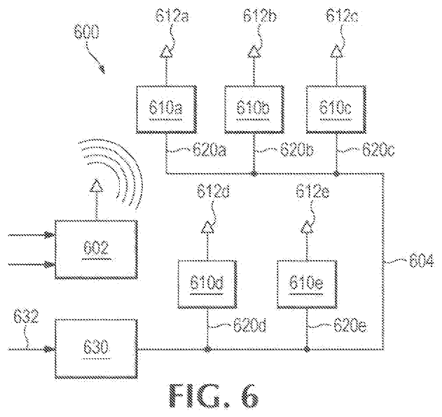

FIG. 3 shows an example flame display unit in more detail. Here, the flame display unit has a rigid housing 204, mountable to an upright support 206 (which may be integrally formed). The flame display unit contains a controller or control circuit 320 which may be connected via wire 220 to a base unit such as 102 in FIG. 1. A wireless option is further described below with regard to FIG. 6. It is noted that a flame display unit in accordance with present disclosure may thus both be connectable to the base unit via a wire and able to receive wireless commands from the base unit. A fuel tank 322, preferably re-fillable, is provided in the flame display unit to provide fuel to generate the flame 210 during operation. The fuel tank 322 is coupled via valve 312 to a burner 318 where a variable flame is emitted through an open aperture 302 in the top of the flame display unit during operation. The control circuit may provide multiple features. It may be coupled to a flame detection sensor 314, for example, a thermocouple. The control circuit may shut off the valve 312 when no flame is detected by sensor 314. During normal operation, the control circuit 320 controls the valve 312 to vary the fuel flow, and thus the flame height, responsive to an analog control signal, as described in more detail below. In some embodiments, the controller 320 may further be coupled to an igniter 308, positioned adjacent the burner 318, to ignite the flame to begin operation. In some embodiments, a button 316 may also be provided to enable manual actuation of the ignitor.

FIG. 4 shows more detail of one arrangement for connecting each flame display unit to the common wire 104. Each flame display unit may have a wire such as 220 connectable to the common wire 104, preferably in removable fashion, for example, using a connector assembly 350. In this way, individual flame display units may be added or removed from the system. The wire 104 is electrically continuous through the connector 350, so that it carries a signal regardless of the number of flame display units that may be connected or disconnected. A plug (not shown) may be used where a flame display unit is not connected to the assembly, in order to protect it from the elements. The wire 104 includes at least two conductors (as illustrated), but it may have more in various arrangements. In some cases, wire 104 may carry only a flame display analog control signal. In other examples, it may also carry a power supply signal such as a DC signal. In a different arrangement, illustrated in FIG. 6, the wire is used only for power; the control signal is broadcast wirelessly.

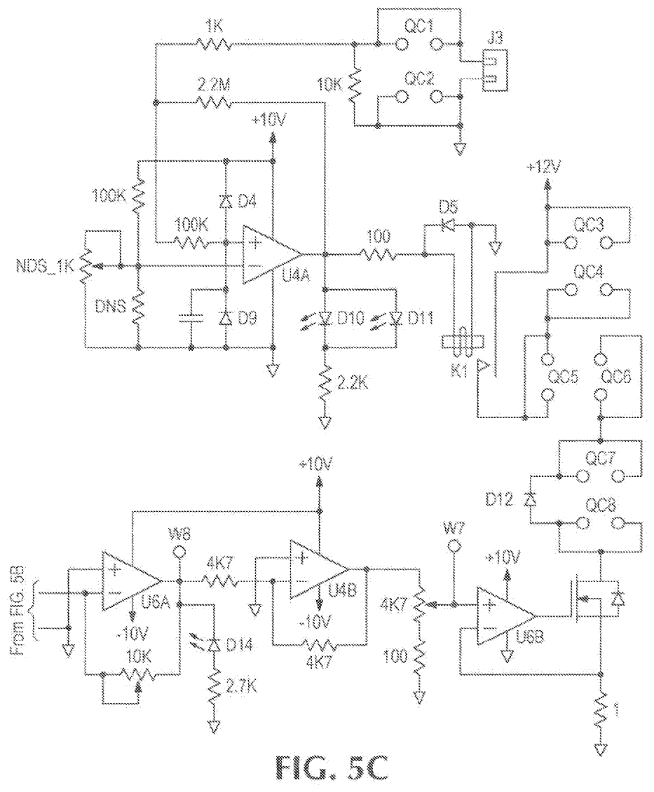

In the schematic diagram of FIGS. 5A-5C, a base unit controller circuit is intended to pulsate/adjust the height of a flame in one or more flame display units, responsive to a musical or other audio input. The controller circuit controls the flow of propane gas or other suitable fuel preferably using a high speed proportional valve to produce an active flame show. The circuit is designed to track the filtered outside envelope of the sound source. The flame height is changed by opening and closing of the gas valve. The system of FIG. 1 expands the control system to utilize multiple flame display units—all controlled by a single controller circuit as mentioned above with regard to FIGS. 1-4.

In more detail, for the controller circuit, a design approach was selected to produce a linear output analog valve position signal with a current feedback closed loop control. The design controls the valve current, not the valve voltage. The open/close action is based on the slope or rate of change of the envelope shape. The design therefore need not specifically extract or analyze the frequency content of the audio signal.

In some embodiments, the concept is to take the audio signal, full-wave rectify it, and low-pass filter the signal to limit changes to the response characteristics of the gas valve. The slope of the filtered signal is determined as positive (+/up) or negative (−/down). If up, the valve is opened; if down, the valve is closed. This up/down voltage may be combined with a DC offset voltage in a current summer circuit. This offset may be used to set the minimum valve drive current. Preferably, this signal both sets a pilot light function and puts the valve at its maximum drive range. The valve selected should have most of its flow capacity in the upper half of its operating current range. In one preferred embodiment, the valve may be Kelly Pneumatics, model number KPI-VPM-10-90-01, commercially available.

The circuit design may be completely analog, for example, using operational amplifiers; it does not contain any microprocessor or digital integrated circuits. The audio source connectivity may utilize a commercial Bluetooth radio/audio source module with outputs to the amplifier(s) come from the Bluetooth module. Additionally or alternatively, various audio content sources, wired or wireless, may be used. A “streaming” audio source may be used, for example, a computer, smartphone, tablet, etc. In other examples, audio source content may be stored locally and need not be streamed. Depending on the audio source, the audio signal may be scaled or otherwise modified.

In an embodiment, the input (supply) voltage may be, for example, 12-15 volts DC. Device outputs may be stereo channels left and right. There may be a flame detection cutoff circuit for safety interlock. Preferably, this is a hysteresis-based operational amplifier circuit for detecting thermocouple voltage outputs. There is a variable resistor to set the detection voltage depending on the type of thermocouple. Failure of the thermocouple flame detection will remove the control voltage from an internal relay which opens the valve drive circuit.

In an embodiment, the design has an internal settable control to provide a minimum drive current to the gas valve. This control is used to provide a minimum DC current to maintain a pilot light function to the fire. The same valve that controls the active flame is also the pilot light valve.

Referring to FIGS. 5A-5C, one example embodiment of a control circuit is shown. The specific components and their values are not intended to be critical or limiting of the general case; they merely show one embodiment. Referring first to FIG. 5A, at the left side, input jacks J1, J2 may be used for audio input signals, or a plug receptacle P1, for example, for Bluetooth audio wires. Operational amplifier AMP-1 provides AC amplifier DC isolation. AMP-2 implements a full-wave rectifier, details of which are well known. FIG. 5A also shows an internal power supply section, see U5, comprising a switched capacitor voltage converter to provide a (−)minus-10 v supply voltage. Voltage regulators U7, U8 and associated components also provide voltage supplies. At test point W3, the full-wave rectified signal is carried over to FIG. 5B.

Referring now to FIG. 5B, a low-pass filter circuit may comprise an op-amp U2A and associated passive components as illustrated. In one example, the op-amp may be an LM258 series IC or the like (an integrated pair of independent, high-gain, frequency-compensated operational amplifiers designed to operate from a single supply or split supply). The low-pass filter preferably may have a characteristic frequency of 500 Hz or thereabouts; the exact frequency is not critical. The frequency should be selected with regard to compatibility with the speed of the proportional valve.

A slope zero-offset summing circuit comprising RV1 offsets the signal voltage, which is then input to differentiator slope detector circuit comprising another op-amp U3A and associated components, producing the resulting signal at test point W 4. In some embodiments, a slope offset circuit may be used if needed, as illustrated at the inverting input to op-amp U3B, comprising the resistor network around potentiometer RV4. The output of amplifier U3B (Test point W5) may be coupled to attack and decay adjusting circuits as illustrated, for example, to generate the signal at Test point W6, which in turn is coupled via D7 to the resistive network. Here the diagram continues on FIG. 5C.

Referring now to FIG. 5C, the signal pair from FIG. 5B is coupled to the inputs to amplifier circuit U6A and thence to U4B to set up valve current. Potentiometer RV7 may be arranged to setup valve current. The amplifier U6B is arranged to control a semiconductor device, such as a MOSFET IRFM120ATF in one example, which is a power MOSFET commercially available from Fairchild Instruments, now a part of ON Semiconductor. In this way, the analog signal output from amplifier U6B controls the current flow in the MOSFET which, in turn, controls current in a valve (not shown), having the valve coil connectable at QC7-QC8. As noted, the concept is to take the audio input signal (FIG. 5A), full wave rectify it, and low-pass filter the signal to limit changes to the response characteristics of the gas valve. The slope of the filtered signal is determined as positive (+/up) or negative (−/down). If up the valve is opened, if down the valve is closed. This up/down voltage is combined with a DC offset voltage in a current summer circuit. This offset is used to set the minimum valve drive current. This both sets a pilot light function and puts the valve in a maximum drive range. The valve may be selected to have most of its flow capacity in the upper half of its operating current range.

In some embodiments, the control circuitry of FIGS. 5A-5C may be deployed in a controller such as 102 in FIG. 1. For example, the analog control signal output from amplifier U6B may be coupled to multiple flame display units in a system such as illustrated in FIG. 1, where the analog control signal is distributed over wire 104. In such applications, each flame display unit 110 may receive the analog control signal via a corresponding connection 220. In each unit, referring to FIG. 3, the analog control signal is input to a local control circuit 320 to control the local valve, based on the control signal.

FIG. 6 illustrates a system 600 in which a base unit 602 is used to control plural flame display units 610. Each flame display unit 610 includes a corresponding antenna 612 to receive a wireless control signal broadcast by the base unit 602, using any of various known short-range wireless technologies. The wireless control signal encodes or carries the analog control signal to the flame display units where each one uses it to control the corresponding valve. In some embodiments, a low-voltage power supply 630 may be used to supply DC power to the flame display units via a wire 604.

The system of FIG. 1 shows a base unit 102 coupled to multiple flame display units 110a-110e. In this type of arrangement, the functionality of the control circuit of FIGS. 5A-5C may be partially “distributed” to the individual flame display units. Specifically, in an embodiment, an analog control signal may be generated based on the signal output at op-amp U6B in FIG. 5C. That is the signal that controls the gate of the MOSFET device. The MOSFET device and associated circuitry may be distributed in the sense that each flame display unit in the system has its own fuel valve, and circuitry to control the valve, such as a MOSFET.

An example is described above with regard to FIG. 3. In more detail, a (local) controller 320 disposed in each flame display unit receives an analog control signal from the base unit (via 220 and 104). The analog control signal is based on the signal output at op-amp U6B in FIG. 5C or a functionally equivalent signal. In various applications, signal voltages, currents, etc. may be arranged differently, as long as the analog signal conveys information for dynamic flame control responsive to the audio input signal at the base unit controller.

In some embodiments, a semiconductor circuit (not shown) may be arranged in the base unit to drive the analog control signal over the distribution wire 104. A high-gain circuit may be used (a Darlington, for example) for fast operation. On the receiving side, the flame display unit control circuit (320) is coupled to the wire 104 to receive the analog control signal. The control circuit may have a high-impedance input stage to receive the voltage without loading the common wire. An op-amp circuit may be used, for example, to then drive the gate of a MOSFET as illustrated in FIG. 5C. In some embodiments, other valve control circuitry shown in FIG. 5 may be provided instead in each individual flame display unit control circuit. Some examples are given in the description of FIG. 3. In general, flame control and safety circuitry may be disposed in each individual flame display unit. The role of the base unit may be limited to generating and distributing the analog control signal responsive to the audio input.

In other embodiments, a feedback signal may be generated by a flame display unit and sent to the base unit, for example a flame-out or low fuel alert.

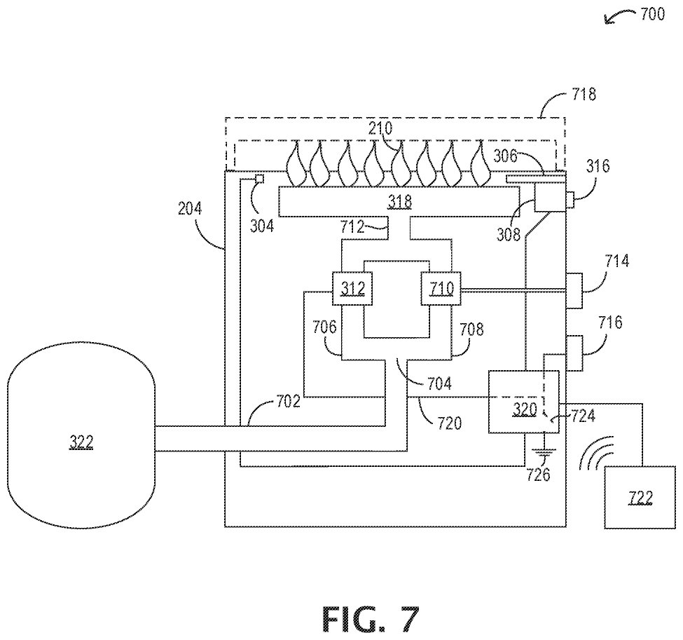

Turning now to FIG. 7, a block diagram of another example flame display unit 700 is shown. For purposes of discussion, similar elements as discussed in the previous figures are labeled similarly and may not be re-introduced. It is noted that reference to upstream and downstream refers to fuel flow in a direction from the fuel source to the burner.

As can be seen in FIG. 7, the flame display unit 700 includes a fuel line passage 702 that extends from fuel tank 322 to a junction 704, at which point the fuel line passage 702 splits into an electric valve fuel passage 706 and a mechanical valve fuel passage 708. An electric valve 312 is positioned in the electric valve fuel passage 706 and a mechanical valve 710 is positioned in the mechanical valve fuel passage 708, where the electric valve fuel passage 706 and the mechanical valve fuel passage 708 are separate passages. Downstream of the electric valve 312 and the mechanical valve 710, the electric valve fuel passage 706 and the mechanical valve fuel passage 708 rejoin and form a further fuel line passage 712. The further fuel line passage 712 is a common fuel passage that is directly connected to burner 318.

The electric valve 312 may receive signals from the flame display unit controller 320 in order to adjust a position of the electric valve. In at least one example, the electric valve 312 may have a low-side driver configuration. In such low-side driver configuration examples, the controller 320 is able to adjust electric valve 312 to a wide open position by grounding a low-side drive input of the electric valve.

The mechanical valve 710 is controlled independently of the electric valve 312 and may be physically coupled to a user input device 714, enabling manual adjustment of the mechanical valve 710 via the user input device 714. In particular, the mechanical valve 710 is a valve physically connected to a user input device 714, where the user input device 714 enables a user to manually adjust the mechanical valve 710. For example, the user input device 714 may be a dial, where turning the dial a first direction may adjust the mechanical valve 710 to a more open position and turning the dial a second direction may adjust the mechanical valve 710 to a more closed position. Thus, via the user input device 714, a user is able to set a base amount of fuel allowed to flow through the mechanical valve 710 for ignition at the burner 318. Though fuel source 312 is shown external to a housing 204 of the flame display unit, it is noted that in one or more examples the fuel source 312 may instead be positioned within the housing 204.

The inclusion of both an electric valve 312 controlled via the controller 320 and a mechanical valve 710 manually adjustable via the user input device 714 enables various operating modes and control for flame production at the burner 318 in a compact manner. Such operating modes may be selected by the user input device 714 and the flame boost input device 716, for example. The operating modes may include a standard operating mode, music mode, and flame boost mode, for example.

In a standard mode, the electric valve 312 may have a base set position that is maintained and a user may provide an input to user input device 714 to set a position of the mechanical valve 710. It is noted that the base set position of the electric valve 312 is not a wide open position in the standard operating mode. That is, the base set position of the electric valve 312 is less open than a wide open position in the standard mode. In at least one example, the base set position of the electric valve 312 may be a closed position for the standard mode. Therefore, with the electric valve 312 in a set base position for the standard operating mode, a user is able to adjust a flame strength by way of the mechanical valve 710 in the standard operating mode.

A music mode may be selected via a user input to the user input device 714. In a music mode, the user may manually set a position of the mechanical valve 710 as described above. That is, the user manually sets a base amount of fuel to be provided to burner 318 for combustion by adjusting the mechanical valve 710 via the user input device. Then, in addition to the position of the mechanical valve 710 set by the user via the user input device 714, the electric valve 312 may further be adjusted responsive to an audio input to provide an additional amount of fuel for combustion in accordance to the audio input. That is, in addition to the fuel provided by way of the mechanical valve 710, the electric valve 312 positon is further continually adjusted to provide additional fuel based on an audio input.

The audio input may be received from a base unit controller 722, where base unit controller 722 may include any one or combination of features of the base units described herein (e.g., base unit 102, base unit 602). For illustration purposes, base unit controller 722 is shown in FIG. 7 as able to provide signals to the flame display unit controller 320 wirelessly and/or via a wired connection. Though both a wired connection and a wireless connection are illustrated between the base unit controller 722 and the controller 320 at FIG. 7, it is noted that only one of a wired connection and a wireless connection may be used. The inclusion of both the wired and wireless connection between the base controller 722 and controller 320 is to show that a wired or wireless connection between the base controller 722 and the controller 320 is possible. It is noted that any one or combination of features discussed herein with regards to controlling the electric valve via an audio input may be implemented.

The result of the electric valve 312 position being continually adjusted to allow additional fuel to flow to the burner responsive to an audio input is a flame display coordinated to the audio input. In particular, in the music mode, a base flame strength is provided by the position of the mechanical valve 710 as set by the user, and the electric valve 312 provides spikes of additional fuel coordinated to the audio input to increase the flame strength in concert with the audio input.

The controller 320 is configured to receive audio input from base unit controller 722 and control the electric valve 312 by providing signals along control wire 720. It is noted that the electric valve 312 may be have a low-side driver configuration, in at least one example. The flame display unit controller 320 in turn is connected to electric valve 312 and actuates electric valve 312 based on audio input.

In order to activate the flame boost mode, a user may provide an input to a flame boost input device 716. The flame boost input device 716 may be a button or other user input device. Providing an input to the flame boost input device 716 actuates switch 724, where the switch 724 may be a mechanical switch. It is noted that the connection from the switch 724 to control wire 720 is shown in dash within controller 320. In a first position, switch 724 is open (as shown in FIG. 7). In the open position, flame boost mode is not activated and the electric valve 312 is not held in a wide open position. In a second position, switch 724 is closed, which connects ground 726 to the control wire 720 to ground the electric valve 312. By grounding electric valve 312, the electric valve 312 is actuated to the wide open position. Thus, responsive to receiving a user request to initiate the flame boost mode, switch 724 is closed and controller 320 commands electric valve 312 to a wide open position and maintains the electric valve 312 in the wide open position for the duration of the flame boost mode. For example, the electric valve 312 may be maintained in the wide open position until a further user input is received to exit the flame boost mode at the flame boost input device 716. Exiting the flame boost mode may include adjusting switch 724 to an open position, and in turn, adjusting the electric valve to a set base position that is less open than the wide open position.

In at least one example, the electric valve 312 has a low-side driver configuration. Thus, in order to adjust the electric valve 312 to the wide open position, flame display unit controller 320 may ground a low-side drive input of the electric valve 312, where the low-side drive input of the electric valve 312 is the control wire 720.

Moreover, in the flame boost mode, the user may set a position of the mechanical valve 710 as described above.

By adjusting the electric valve 312 to the wide open position a maximum amount of fuel flow is allowed to flow through the electric valve fuel passage 706, and in turn, provide a significant increase in flame strength compared to operation in the standard mode. For example, because the flame boost mode maintains the electric valve 312 in the wide open position, a user has the option to adjust the mechanical valve 710 to a wide open position via the user input device 714 to provide a maximum fuel flow through both the electric valve fuel passage 706 and the mechanical valve fuel passage 708. In turn, a maximum strength flame may be provided at the burner 318. This flame boost mode may be particularly useful for heating an accessory 718, such as a griddle or grill, as it provides highly effective heating.

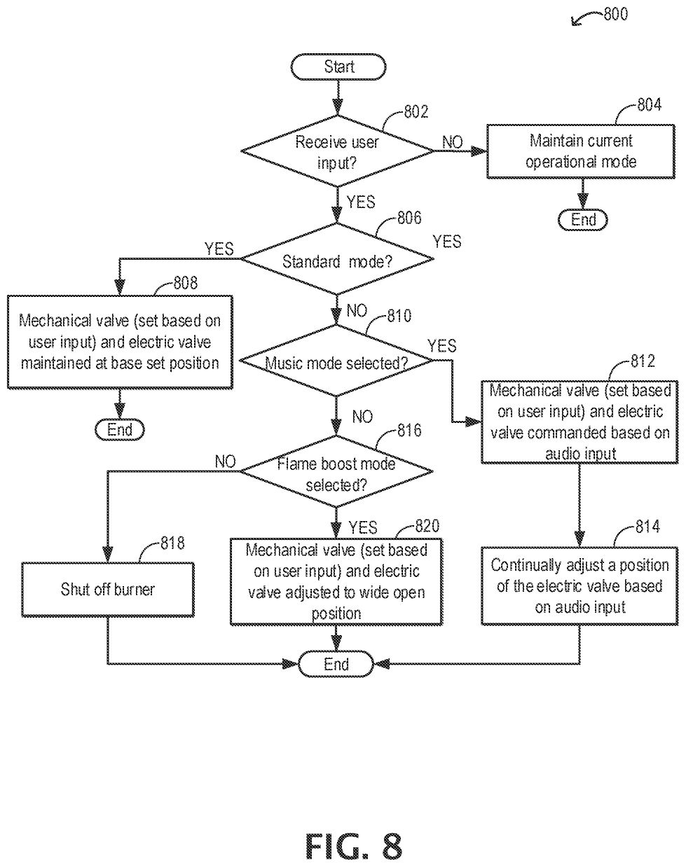

Turning now to FIG. 8, FIG. 8 shows a flow chart of a method 800, according to one or more examples. Method 800 may be carried out in conjunction with any one or combination of systems disclosed herein. Instructions for carrying out method 800 and the rest of the methods included herein may be executed by a controller base unit controller and flame display controller based on instructions stored on a memory of the base unit controller and flame display controller, and in conjunction with signals received from sensors of the system, such as the sensors described above with reference to the preceding figures. The controller may employ actuators of the system to adjust operation, according to the methods described below.

At step 802 of method 800, it is detected whether or not a user input has been received at a flame display unit. It is noted that the flame display unit may comprise a user input device (e.g., user input device 714 and/or flame boost input device 716), such as a dial, button, or other device able to receive a user input to indicate an operational mode selection for the flame display unit. In a case of a dial, the dial may be turned to different positions, and the position of the dial may be used to determine which operational mode is selected by the user.

If a user input has not been detected (“NO”) at step 802, then method 800 proceeds to step 804 and maintains the current operational mode of the flame display unit. Following step 804, method 800 may end. Alternatively, if it is detected that a user input has been received at step 802 (“YES”), then method 800 proceeds to determine which of the standard mode, music mode, and flame boost mode is selected and to adjust the electric valve of the flame display accordingly.

At step 806, it is determined whether or not a standard mode is selected. In at least one example, the standard mode may be determined as selected responsive to a user input received at the user input device to control the mechanical valve in combination with the absence of user selection of a music mode and the absence of user selection of a flame boost mode. In at least one example, this may include a user input at a user input device to adjust the mechanical valve without input at a flame boost input device to request flame boost mode and without requesting a music mode at the user input device. If it is determined the standard mode is selected at step 806 (“YES”), method 800 includes adjusting a mechanical valve (e.g., mechanical valve 710) responsive to the user input received at the user input device at step 808.

Specifically, in the standard mode, the mechanical valve is adjusted to a position set based on the user input and then maintained in the position until a further user input is received. In a case where the user input device is a dial, the dial may be twisted within a particular range that is designated to indicate the standard mode, thus adjusting the mechanical valve position and turning the fire up or down within the standard mode range.

The controller controls the electric valve to be positioned and maintained in a base set position in the standard mode, where the base set position of the electric valve is less open than a wide open position. Even if an audio input is available, the electric valve is maintained at the base set position in the standard mode. If the fuel was not already ignited at a burner of the display unit at step 808, then step 808 may further comprise actuating an igniter to ignite fuel flowed from the fuel source to the burner as a result of adjusting the electric valve. Method 800 may then end.

If it is determined that the standard mode is not selected at step 806 (“NO”) and it is determined that a music mode is selected at step 810 (“YES”) based on input received at the user input device, then method 800 proceeds to step 812.

At step 812, responsive to determining that the music mode is selected, the electric valve is commanded based on an audio input. The mechanical valve is additionally set to a position by the user as described above. If the fuel was not already ignited at a burner of the display unit at step 812, then step 812 may further comprise actuating an igniter to ignite fuel flowed to the burner. In the music mode, a position of the electric valve is continually adjusted based on an audio input at step 814. It is noted that disclosure herein as to control of the electric valve based on an audio input may be applied to controlling the electric valve at steps 812 and 814.

Thus, in the music mode, the mechanical valve position set by the user establishes a base amount of fuel flowed to the burner and the electric valve provides additional fuel to the burner coordinated to the audio input. Method 800 may then end.

If it is determined that the music mode is not selected at step 810 (“NO”) from the user input received, and it is determined a flame boost mode is not selected at step 816 (“NO”), then method 800 may proceed to shut off the burner of the flame display unit at step 818. In at least one example, shutting off the burner may include adjusting one or more of the electric valve and the mechanical valve to a fully closed position. In other examples, however, a pilot light as previously described may be maintained in the shut off state. Method 800 may then end.

If it is determined that the flame boost mode is selected at step 816 (“YES”), then method 800 proceeds to step 820 to position the electric valve to a wide open position and maintain the electric valve at the wide open position. By positioning the electric valve to the wide open position and maintaining the electric valve in the wide open position in the flame boost mode, a maximum amount of fuel is allowed to flow through the electric valve. Thus, the flame boost mode provides the ability to flow the maximum amount of fuel to the burner. This may be particularly useful if high heat is desired for heating an accessory such as a grill or griddle, for example.

In at least one example, the electric valve may be in a low-side driver configuration and thus positioning and maintaining the electric valve in the wide open position may include grounding a low-side drive input of the electric valve. In particular, as described above, the flame boost mode may be selected via a user input to the flame boost input device 716. Such an input adjusts a position of a switch (e.g., switch 724). In the case of activating a flame boost mode, adjusting the switch may include adjusting the switch from an open position to a closed position. This grounding may be carried out by the flame display unit controller and/or by the user's mechanical input coupling a signal line for the valve to ground, which causes the electrically controlled valve to be held, continuously, at full open all the while that the boost input device 716 (e.g., a mechanical user-adjusted switch or button) is in the flame boost position. If the fuel was not already ignited at a burner of the display unit at step 820, then step 820 may further comprise actuating an igniter to ignite fuel flowed from the fuel source to the burner as a result of adjusting the electric valve and/or mechanical valve. Method 800 may then end.

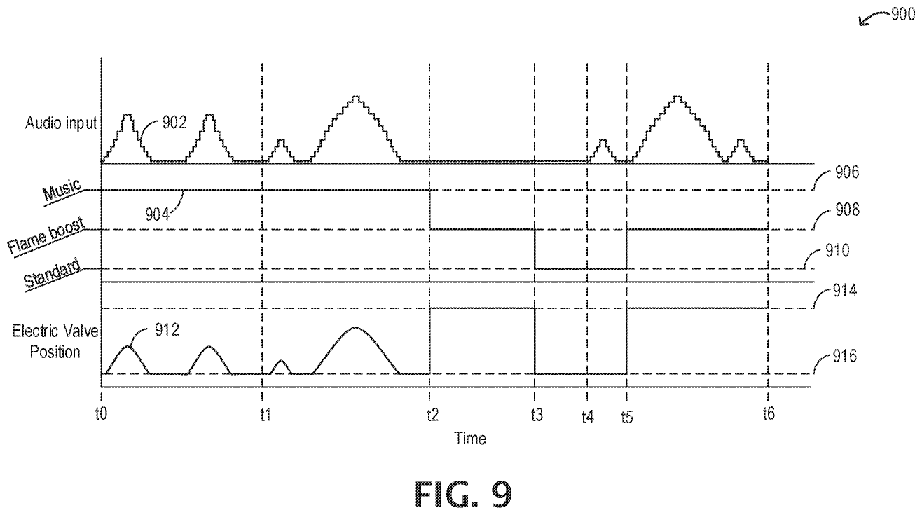

Turning now to FIG. 9, FIG. 9 shows a timing diagram 900 for controlling an electric valve of a flame display unit according to at least one example of the present disclosure. As may be seen in FIG. 9, an audio input, mode, and electric valve position are all illustrated across a common time axis.

The top graph shows an example audio input 902 received at the flame display unit. As discussed in the present disclosure, such an audio input may be output from a base station to a controller of the flame display unit. The audio input 902 shown is a digitized representation of a filtered audio signal at timing diagram 900, where audio input 902 is used for generating a wireless control signal encoding or carrying the analog control signal to control the electric valve of the flame display unit. In some embodiments, a low-voltage power supply 630 may be used to supply DC power to the flame display units via a wire 604.

However, it is noted that an analog audio input is also possible, in one or more examples. As previously discussed, the controller (e.g., controller 320) may utilize audio input signals to provide analog commands to control the electric valve.

The middle graph indicates a mode 904 that is selected for operation of the flame display unit. The mode 904 may be selected via a user input device and/or a flame boost input device, as discussed herein. As seen in the middle graph, dash line 906 represents selection of the music mode, dash line 908 represents selection of the flame boost mode, and dash line 910 represents selection of the standard mode.

The bottom graph shows an example electric valve position 912. The electric valve position 912 ranges from a wide open position 914 to a base position 916 for the electric valve. It is noted that an electric valve position 912 is more open when illustrated closer to the wide open position 914 and more closed when illustrated closer to the base electric valve position 916.

At time t0, music mode 906 is the mode 904 selected. In the music mode 906, electric valve position 912 can be seen as being coordinated with the audio input 902. In particular, the audio input 902 is sent from a base unit to a controller of the flame display unit. The controller of the flame display unit then adjusts a position of the electric valve 912 based on the audio input received, as discussed previously herein. Thus, peaks in the audio input 902 may be translated into increased openings in the electric valve 912.

As can be seen in FIG. 9, the magnitude of the peaks from the audio input 902 impact a position of the electric valve 912, where the larger the magnitude, the more open the electric valve 912. For example, as can be seen from t0 to t1, two similar magnitude peaks from the audio input result in similar electric valve positioning 912. Further, as seen from t1 to t2, a smaller magnitude peak from the audio input 902 results in a less open electric valve position 912, and a larger magnitude peak from the audio input 902 results in a more open electric valve position 912. The more open the electric valve position, the more fuel is allowed to through the electric valve and thus the larger the flame. In this way, the electric valve position 912 is continually adjusted and coordinated with the audio input 902 in the music mode.

Flame boost mode 908 is selected at time t2, which results in the electric valve position 912 being adjusted to a wide open position 914. Even though no audio input 902 is being received from time t2 to t3, since the flame boost mode 908 is selected, the electric valve position 912 is maintained at the wide open position. In this way, a maximum amount of fuel is allowed to pass through the electric valve in the flame boost mode 908.

Standard mode is selected at time t3, resulting in the electric valve position 912 being adjusted to a base position 916. The base position 916 may be a closed position in some examples. However, in at least one example, the electric valve 912 may be at least partially open at the base position 916. Even though audio input 902 is received from t4 to t5, the electric valve position is maintained at the base position 916 due to the selection of the standard mode 910.

At time t5, the flame boost mode 908 is selected once again, and the electric valve position 912 is again adjusted to the wide open position 914. Though audio input 902 is received at time t5 to time t6 with varied peaks, the electric valve position 912 is maintained at the wide open position 914. That is, the selection of the flame boost mode 908 overrides any audio input 902, and the electric valve position 912 is maintained in the wide open position. This ensures that a maximum amount of fuel is allowed to flow through the electric valve during flame boost mode 908 regardless of audio input 902.

The disclosure also provides support for a method for a flame display, comprising: flowing fuel from a fuel source to a burner via an electric valve fuel passage that includes an electric valve and via a mechanical valve fuel passage that includes a mechanical valve, receiving a user input at a flame boost input device requesting a flame boost mode, and adjusting the electric valve positioned in the electric valve fuel passage to a wide open position. In a first example of the method, the electric valve is maintained in the wide open position responsive to the user input requesting the flame boost mode until a further user input is received at the flame boost input device to exit the flame boost mode. In a second example of the method, optionally including the first example, the electric valve is adjusted to the wide open position by grounding the electric valve. In a third example of the method, optionally including one or both of the first and second examples, the method further comprises: receiving the further user input at the flame boost input device requesting to exit the flame boost mode, and adjusting the electric valve positioned in the electric valve fuel passage to a base set position that is less open than the wide open position. In a fourth example of the method, optionally including one or more or each of the first through third examples, a position of the mechanical valve is adjusted manually via a user input device physically coupled to the mechanical valve. In a fifth example of the method, optionally including one or more or each of the first through fourth examples, the electric valve fuel passage and the mechanical valve fuel passage are separate passages. In a sixth example of the method, optionally including one or more or each of the first through fifth examples, the method further comprises: receiving a user input at a user input device requesting a music mode, and adjusting the electric valve responsive to an audio input. In a seventh example of the method, optionally including one or more or each of the first through sixth examples, the mechanical valve is adjustable via the user input device in the music mode, and wherein the electric valve is continually adjusted to provide additional fuel in coordination with the audio input.

The disclosure also provides support for a flame display system, comprising: a fuel source coupled to a burner via an electric valve fuel passage and via a mechanical valve fuel passage, an electric valve coupled in the electric valve fuel passage, a user input device physically coupled to the mechanical valve, a flame boost input device communicatively coupled to a controller of the flame display, the controller comprising instructions stored in non-transitory memory executable to: receive a request to initiate flame boost mode via the flame boost input device, and adjust the electric valve to a wide open position. In a first example of the system, the a position of the mechanical valve is adjusted via the user input device. In a second example of the system, optionally including the first example, a fuel line passage directly coupled to the fuel source splits into the electric valve fuel passage and the mechanical valve fuel passage at a junction upstream of both the electric valve and the mechanical valve. In a third example of the system, optionally including one or both of the first and second examples, the electric valve and the mechanical valve are controlled independently of one another. In a fourth example of the system, optionally including one or more or each of the first through third examples, the controller further comprises instructions to adjust the electric valve based on an audio input responsive to a request for music mode operation. In a fifth example of the system, optionally including one or more or each of the first through fourth examples, the electric valve is in a low-side driver configuration, and wherein the electric valve is adjusted to the wide open position by grounding a low-side driver input of the electric valve.

The disclosure also provides support for a method for a flame display, comprising: flowing fuel from a fuel source to a burner via a first fuel passage and a second fuel passage that are separate from one another, wherein the first fuel passage includes an electric valve positioned therein and the second fuel passage includes a mechanical valve positioned therein, adjusting the mechanical valve manually via a user input device, receiving a user input requesting initiation of a flame boost mode, and adjusting the electric valve to a wide open position in response to receiving the request to initiate the flame boost mode by grounding the electric valve. In a first example of the method, the electric valve is maintained in the wide open position for a duration of the flame boost mode. In a second example of the method, optionally including the first example, a controller of the flame display receives the request for input of the flame boost mode and grounds the electric valve responsive to the request for input of the flame boost mode. In a third example of the method, optionally including one or both of the first and second examples, the method further comprises: receiving a further user input requesting a music mode, and adjusting the electric valve based on an audio input in response to the request for the music mode. In a fourth example of the method, optionally including one or more or each of the first through third examples, the controller receives the request for a music mode and the audio input, and wherein the controller adjusts a position of the electric valve based on the audio input. In a fifth example of the method, optionally including one or more or each of the first through fourth examples, the mechanical valve is adjusted manually and independently of the electric valve in both the flame boost mode and the music mode.

FIGS. 1-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Note that the example control routines included herein can be used with various fire display configurations. The control methods disclosed herein may be stored as executable instructions in non-transitory memory and may be carried out by a base controller and flame display unit controller in combination with the various sensors, actuators, and other hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein. As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for a flame display, comprising:
flowing fuel from a fuel source to a burner via an electric valve fuel passage that includes an electric valve and via a mechanical valve fuel passage that includes a mechanical valve;
receiving a user input at a flame boost input device requesting a flame boost mode; and
adjusting the electric valve positioned in the electric valve fuel passage to a wide open position.

2. The method of claim 1, wherein the electric valve is maintained in the wide open position responsive to the user input requesting the flame boost mode until a further user input is received at the flame boost input device to exit the flame boost mode.

3. The method of claim 2, wherein the electric valve is adjusted to the wide open position by grounding the electric valve.

4. The method of claim 2, further comprising receiving the further user input at the flame boost input device requesting to exit the flame boost mode, and adjusting the electric valve positioned in the electric valve fuel passage to a base set position that is less open than the wide open position.

5. The method of claim 1, wherein a position of the mechanical valve is adjusted manually via a user input device physically coupled to the mechanical valve.

6. The method of claim 1, wherein the electric valve fuel passage and the mechanical valve fuel passage are separate passages.

7. The method of claim 1, further comprising receiving a user input at a user input device requesting a music mode, and adjusting the electric valve responsive to an audio input.

8. The method of claim 7, wherein the mechanical valve is adjustable via the user input device in the music mode, and wherein the electric valve is continually adjusted to provide additional fuel in coordination with the audio input.

9. A flame display system, comprising:
a fuel source coupled to a burner via an electric valve fuel passage and via a mechanical valve fuel passage;
an electric valve coupled in the electric valve fuel passage;
a user input device physically coupled to a mechanical valve;
a flame boost input device communicatively coupled to a controller of the flame display, the controller comprising instructions stored in non-transitory memory executable to:
receive a request to initiate flame boost mode via the flame boost input device, and
adjust the electric valve to a wide open position.

10. The flame display system of claim 9, wherein a position of the mechanical valve is adjusted via the user input device.

11. The flame display system of claim 9, wherein a fuel line passage directly coupled to the fuel source splits into the electric valve fuel passage and the mechanical valve fuel passage at a junction upstream of both the electric valve and the mechanical valve.

12. The flame display of claim 11, wherein the electric valve and the mechanical valve are controlled independently of one another.

13. The flame display system of claim 9, wherein the controller further comprises instructions to adjust the electric valve based on an audio input responsive to a request for music mode operation.

14. The flame display system of claim 9, wherein the electric valve is in a low-side driver configuration, and wherein the electric valve is adjusted to the wide open position by grounding a low-side driver input of the electric valve.

15. A method for a flame display, comprising:
flowing fuel from a fuel source to a burner via a first fuel passage and a second fuel passage that are separate from one another, wherein the first fuel passage includes an electric valve positioned therein and the second fuel passage includes a mechanical valve positioned therein;
adjusting the mechanical valve manually via a user input device;
receiving a user input requesting initiation of a flame boost mode; and
adjusting the electric valve to a wide open position in response to receiving the request to initiate the flame boost mode by grounding the electric valve.

16. The method of claim 15, wherein the electric valve is maintained in the wide open position for a duration of the flame boost mode.

17. The method of claim 16, wherein a controller of the flame display receives the request for input of the flame boost mode and grounds the electric valve responsive to the request for input of the flame boost mode.

18. The method of claim 17, further comprising receiving a further user input requesting a music mode, and adjusting the electric valve based on an audio input in response to the request for the music mode.

19. The method of claim 18, wherein the controller receives the request for a music mode and the audio input, and wherein the controller adjusts a position of the electric valve based on the audio input.

20. The method of claim 19, wherein the mechanical valve is adjusted manually and independently of the electric valve in both the flame boost mode and the music mode.
